(19) United States
(12) Patent Application Publication
(10) Pub. No.: US 2013/0002960 A1
(43) Pub. Date: Jan. 3, 2013

(54) Signal Controller For Display Device, Display Device, And Driving Method Thereof

(76) Inventors: Jae-Woo Ryu, Yongin-city (KR); Hyun-Suk Roh, Yongin-city (KR)

(21) Appl. No.: 13/369,101

(22) Filed: Feb. 8, 2012

(30) Foreign Application Priority Data
Jun. 28, 2011 (KR) 10-2011-0063168

(51) Int. Cl. H04N 5/00; G09G 5/02

(52) U.S. Cl. 348/607; 345/698; 348/E05.077

(57) ABSTRACT

A display device includes a display unit including a plurality of pixels, and a signal controller for generating a compensation image data signal for offsetting a difference of a deterioration degree of a pixel from among the plurality of pixels, based on a data accumulation value of an input video signal of the pixel for displaying a normal image to the display unit, wherein the signal controller is configured to generate the compensation image data signal for offsetting a difference between a maximum data accumulation value of a maximum light emitting pixel from among the plurality of pixels and each data accumulation value of remaining pixels from among the plurality of pixels.

### CROSS-REFERENCE TO RELATED APPLICATION

This application claims priority to and the benefit of Korean Patent Application No. 10-2011-0063168 filed in the Korean Intellectual Property Office on Jun. 28, 2011, the entire contents of which are incorporated herein by reference.

### BACKGROUND

1. Field

Embodiments of the present invention relate to a signal controller for a display device, a display device, and a driving method thereof.

2. Description of Related Art

Various flat panel displays that comparatively reduce the weight and volume that are drawbacks of the cathode ray tube have been developed. As flat panel displays, there are a liquid crystal display (LCD), a field emission display (FED), a plasma display panel (PDP), and an organic light emitting diode (OLED) display.

The OLED display uses an OLED having luminance that is controlled by a current or a voltage. The OLED includes an anode and a cathode for forming an electric field, and an organic light emitting material for emitting light due to the electric field.

A decrease in luminance of a pixel according to deterioration of the organic light emitting material must be corrected for commercialization of the OLED display. Although a constant current is supplied to the pixel, the pixel emits light with deteriorated luminance, in comparison to an initial luminance, due to the deterioration of the organic light emitting material. Also, although a constant voltage is applied to the pixel, the current flowing to the pixel decreases due to the deterioration of the organic light emitting material, and the luminance of the pixel is thereby decreased.

The decrease in luminance of the pixel may be compensated by increasing the voltage or the current applied to all pixels of the display. However, the gray level displayed for each pixel according to the display image may become different, and a difference of deterioration degree may be generated in each pixel. The difference of the deterioration degree in each pixel (e.g., the difference in the degree each pixel is deteriorated) causes a luminance difference between pixels. The luminance difference between pixels is not compensated even if the voltage or the current applied to all pixels is increased.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a signal controller for a display device for compensating a luminance difference between pixels according to deterioration of the pixels, a display device, and a driving method thereof.

A display device according to an exemplary embodiment of the present invention includes a display unit including a plurality of pixels, and a signal controller for generating a compensation image data signal for offsetting a difference of a deterioration degree of a pixel from among the plurality of pixels, based on a data accumulation value of an input video signal of the pixel for displaying a normal image to the display unit, wherein the signal controller is configured to generate the compensation image data signal for offsetting a difference between a maximum data accumulation value of a maximum light emitting pixel from among the plurality of pixels and each data accumulation value of remaining pixels from among the plurality of pixels.

The signal controller may be configured to add a weight value coefficient of each of the plurality of pixels to the data accumulation value for a corresponding one of the plurality of pixels to obtain the maximum data accumulation value of the maximum light emitting pixel and each data accumulation value of the remaining pixels.

The weight value coefficient of each of the plurality of pixels may correspond to the data accumulation value remaining after compensation by the compensation image data signal for offsetting the difference between the maximum data accumulation value of the maximum light emitting pixel and the data accumulation value of each of the remaining pixels.

The signal controller may be configured to generate the compensation image data signal for a compensation image to be displayed between a plurality of normal images in a cycle.

The signal controller may be configured to generate an image data signal to display the normal image to increase respective pixel currents flowing to the plurality of pixels in reference to the deterioration degree of the maximum light emitting pixel.

A signal controller for a display device according to another exemplary embodiment of the present invention includes a data accumulator for accumulating an input video signal corresponding to a pixel of a plurality of pixels to display a normal image, a memory for storing a data accumulation value corresponding to the pixel, the data accumulation value being accumulated with the input video signal corresponding to the pixel, and a compensation image generator for generating a compensation image data signal for offsetting a difference between a maximum data accumulation value of a maximum light emitting pixel from among the plurality of pixels and the data accumulation value of each of remaining pixels from among the plurality of pixels.

The compensation image generator may be configured to add a weight value coefficient of each of the plurality of pixels to the data accumulation value for the pixel to obtain the maximum data accumulation value of the maximum light emitting pixel and each data accumulation value of the remaining pixels.

Each weight value coefficient of the plurality of pixels may be determined according to the data accumulation value remaining after compensation by the compensation image data signal for offsetting the difference between the maximum data accumulation value of the maximum light emitting pixel and each data accumulation value of the remaining pixels.

The memory may be configured to store the data accumulation value for the pixel during a data accumulation period, to transmit the data accumulation value for the pixel to the compensation image generator, and to initialize the data accumulation value for the pixel.

The compensation image generator may be configured to generate the compensation image data signal for a compensation image to be displayed between a plurality of normal images in a cycle.

The compensation image generator may be configured to generate an image data signal to display the normal image to increase respective pixel currents flowing to the plurality of pixels in reference to a deterioration degree of the maximum light emitting pixel.

A driving method of a display device according to another exemplary embodiment of the present invention includes displaying a plurality of normal images generated by an image data signal and accumulating the image data signal for a pixel to store a data accumulation value for the pixel, and displaying a compensation image generated by a compensation image data signal to offset a difference of a deterioration degree for the pixel, wherein the compensation image data signal offsets differences between a maximum data accumulation value of a maximum light emitting pixel from among a plurality of pixels and data accumulation values of each of remaining pixels from among the plurality of pixels.

The compensation image may be displayed between the plurality of normal images in a cycle.

A weight value coefficient of each of the plurality of pixels may be added to the data accumulation value for the pixel to obtain the maximum data accumulation value and each data accumulation value of the remaining pixels.

Each weight value coefficient of the plurality of pixels may be determined according to the data accumulation value remaining after compensation by the compensation image data signal for offsetting the differences between the maximum data accumulation value of the maximum light emitting pixel and each data accumulation value of the remaining pixels.

The method may further include increasing respective pixel currents flowing to the plurality of pixels in reference to the deterioration degree of the maximum light emitting pixel to compensate deterioration of all of the pixels.

The difference of the deterioration degree for the pixel may be offset through storing the data accumulation value, and the luminance difference between the pixels according to the deterioration of the pixel may be compensated. Also, all pixels are deteriorated by the same degree such that the deterioration of all pixels may be uniformly compensated.

### BRIEF DESCRIPTION OF THE DRAWINGS

FIG. 1 is a block diagram of a display device according to an exemplary embodiment of the present invention.

FIG. 2 is a circuit diagram of one example of a pixel.

FIG. 3 is a block diagram of a signal controller according to an exemplary embodiment of the present invention.

FIG. 4 is a view of a method for compensating a luminance difference between pixels according to deterioration of a pixel according to an exemplary embodiment of the present invention.

FIG. 5 is a graph of a deterioration curve of a pixel according to time.

FIG. 6 is a graph of a luminance curve of a pixel with regard to current.

### DETAILED DESCRIPTION

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Further, in the embodiments of the present invention, like reference numerals designate like elements throughout the specification representatively in a first embodiment, and only elements of other embodiments other than those of the first embodiment may be described.

Descriptions of parts not related to the exemplary embodiments of the present invention may be omitted.

Throughout this specification and the claims that follow, when it is described that an element is “coupled” to another element, the element may be “directly coupled” to the other element or “electrically coupled” to the other element through one or more other elements. In addition, unless explicitly described to the contrary, the word “comprise” and variations such as “comprises” or “comprising” will be understood to imply the inclusion of stated elements but not the exclusion of any other elements.

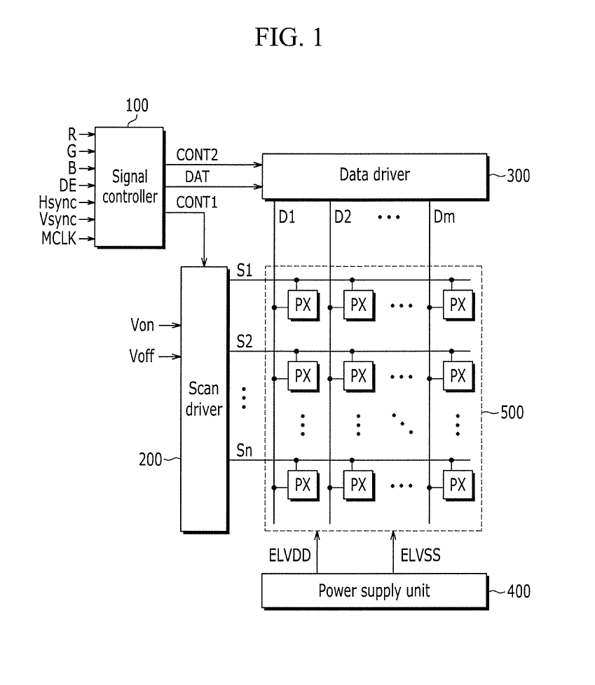

FIG. 1 is a block diagram of a display device according to an exemplary embodiment of the present invention.

Referring to FIG. 1, a display device includes a signal controller 100, a scan driver 200, a data driver 300, a power supply unit 400, and a display unit 500.

The signal controller 100 receives input video signals R, G, and B that are inputted from an external device, and input control signals that control displaying thereof. The video signals R, G, and B include luminance of each pixel PX, and the luminance has a gray level having a number (e.g., a predetermined number, for example, 1024=2¹⁰, 256=2⁸, or 64=2⁶). Examples of the input control signals include a vertical synchronization signal Vsync, a horizontal synchronization signal Hsync, a main clock signal MCLK, and a data enable signal DE.

The signal controller 100 appropriately processes the input video signals R, G, and B according to an operation condition of the display unit 500 and the data driver 300 on the basis of the input video signals R, G, and B and the input control signals, and generates a scan control signal CONT1, a data control signal CONT2, and an image data signal DAT. The signal controller 100 transmits the scan control signal CONT1 to the scan driver 200. The signal controller 100 transmits the data control signal CONT2 and the image data signal DAT to the data driver 300.

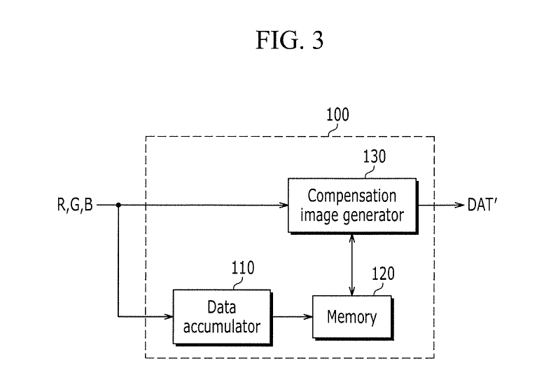

Also, the signal controller 100 generates a compensation image data signal DAT′ (e.g., see FIG. 3) to offset a difference of a deterioration degree for a pixel based on a data accumulation value for the pixel of the input video signals R, G, and B. The compensation image data signal DAT′ is an image data signal for offsetting the difference between the maximum data accumulation value of the maximum light emitting pixel among a plurality of pixels PX and the data accumulation value of each pixel of remaining pixels among the plurality of pixels PX (e.g., pixels other than the maximum light emitting pixel). The signal controller 100 adds each weight value coefficient of each of the plurality of pixels PX to the data accumulation value for the pixel to obtain the maximum data accumulation value and each data accumulation value of the remaining pixels. Each weight value coefficient of each of the plurality of pixels PX may be determined according to the data accumulation value that remains after compensation by the previously generated compensation image data signal of the differences between the maximum data accumulation value and each data accumulation value of the remaining pixels.

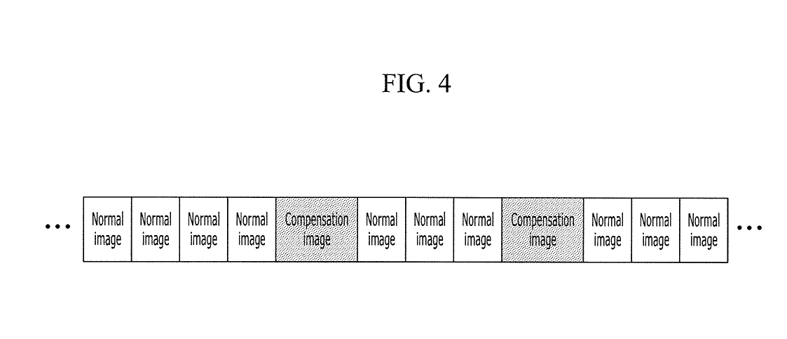

The signal controller 100 may process to display the compensation image using the compensation image data signal DAT with a cycle (e.g., a predetermined cycle) between normal images displayed by the image data signal DAT (e.g., see FIG. 4). The difference of the deterioration degree for the pixel may be offset according to the display of the compensation image.

Also, the signal controller 100 may generate the image data signal DAT for the pixel current flowing to the plurality of pixels PX to be increased with reference to the deterioration degree of the maximum light emitting pixel.

The display unit 500 of the present embodiment includes a plurality of scan lines S1-Sn, a plurality of data lines D1-Dm, and a plurality of pixels PX coupled to the plurality of signal lines S1-Sn and data lines D1-Dm and arranged in an approximate matrix. The plurality of scan lines S1-Sn are extended in a row direction and are substantially in parallel with each other, and the plurality of data lines D1-Dm are extended in a column direction and are substantially in parallel with each other.

The scan driver 200 is coupled to the plurality of scan lines S1-Sn, and applies scan signals that include a combination of a gate-on voltage Von and a gate-off voltage Voff to the plurality of scan lines S1-Sn according to the scan control signal CONT1. The scan driver 200 may sequentially apply the scan signals to the plurality of scan lines S1-Sn.

The data driver 300 is coupled to the plurality of data lines D1-Dm, and applies data signals to the plurality of data lines D1-Dm according to the data control signal CONT2. The data voltage Vdat may be selected according to the gray level of the image data signal DAT or the compensation image data signal DAT′.

The power supply unit 400 supplies a first power source voltage ELVDD and a second power source voltage ELVSS to the display unit 500.

Each driving device 100, 200, 300, or 400 may be, according to embodiments of the present invention, directly mounted on the display unit 500 in the form of at least one integrated circuit chip, mounted on a flexible printed circuit film, attached to the display unit 500 in the form of a tape carrier package (TCP), or mounted on a separate printed circuit board (PCB). Alternatively, they may be integrated in the display unit 500 together with the signal lines S1-Sn and data lines D1-Dm.

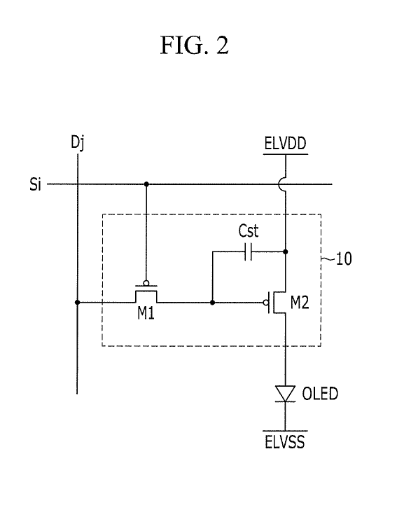

FIG. 2 is a circuit diagram of one example of a pixel.

Referring to FIG. 2, the pixel of the organic light emitting diode (OLED) display includes an OLED and a pixel circuit 10 to control the OLED. The pixel circuit 10 includes a switching transistor M1, a driving transistor M2, and a sustain capacitor Cst.

The switching transistor M1 includes a gate electrode coupled to a scan line Si, one terminal coupled to a data line Dj, and the other terminal coupled to a gate electrode of the driving transistor M2. The switching transistor M1 is turned on by the scan signal of the gate-on voltage Von applied to the scan line Si such that the data voltage Vdat applied to the data line Dj is applied to the gate electrode of the driving transistor M2.

The driving transistor M2 includes the gate electrode coupled to the other terminal of the switching transistor M1, one terminal applied with the first power source voltage ELVDD, and the other terminal coupled to the anode of the OLED. The driving transistor M2 controls an amount of current flowing to the OLED according to the data voltage Vdat applied to the gate electrode.

The sustain capacitor Cst includes one terminal coupled to the gate electrode of the driving transistor M2 and the other terminal applied with the first power source voltage ELVDD. The sustain capacitor Cst charges the data voltage Vdat applied to the gate electrode of the driving transistor M2 and maintains it after the switching transistor M1 is turned off.

The OLED includes the anode coupled to the other terminal of the driving transistor M2 and the cathode applied with the second power source voltage ELVSS. The OLED may emit light of, for example, one of primary colors. The primary colors include, for example, three primary colors of red, green, and blue, and a desired color may be displayed with a spatial or temporal sum of the three primary colors.

The switching transistor M1 and the driving transistor M2 may be p-channel field effect transistors, wherein the gate-on voltage turning on the switching transistor M1 and the driving transistor M2 (e.g., Von) is a logic low level voltage, and the gate-off voltage turning them off (e.g., Voff) is a logic high level voltage.

The switching transistor M1 and the driving transistor M2 of the present embodiment are p-channel field effect transistors. However at least one of the switching transistor M1 and the driving transistor M2 may be an n-channel field effect transistor, and the gate-on voltage for turning on the n-channel field effect transistor (e.g., Von) is the logic high voltage, while the gate-off voltage for turning it off (e.g., Voff) is the logic low voltage.

The scan driver 200 applies the gate-on voltage Von to the scan line Si according to the scan control signal CONTI to turn on the switching transistor M1. Here, the data driver 300 applies the data voltage of the logic low level to the data line Dj according to the data control signal CONT2. The sustain capacitor Cst is charged by the data voltage, and the driving transistor M2 is turned on. The current corresponding to the data voltage flows to the OLED through the turned on driving transistor M2. The OLED emits the light corresponding to the amount of current flowing through the driving transistor M2.

Here, a pixel including two transistors and one capacitor is described. However, the display device according to embodiments of the present invention may use a pixel of various structures, as well as, or instead of, the pixel of FIG. 2.

Next, a configuration and an operation of a signal controller for compensating the difference of the deterioration degree for the pixel of an embodiment of the present invention will be described.

FIG. 3 is a block diagram of a signal controller according to an exemplary embodiment of the present invention.

Referring to FIG. 3, the signal controller 100 includes a data accumulator 110, a memory 120, and a compensation image generator 130.

The input video signals R, G, and B input to the signal controller 100 are transmitted to the data accumulator 110 and the compensation image generator 130.

The data accumulator 110 accumulates the input video signals R, G, and B for the pixel. The data accumulator 110 transmits, to the memory 120, the data accumulation value of the input video signals R, G, and B for the pixel.

The memory 120 stores the data accumulation value for the pixel, in which the input video signals R, G, and B are accumulated for the pixel. The memory 120 transmits the data accumulation value for the pixel stored during a data accumulation period (e.g., a predetermined data accumulation period) to the compensation image generator 130. The memory 120 may transmit the data accumulation value for the pixel to the compensation image generator 130 and then initialize the accumulation data stored for the pixel, such that the amount of stored data is not excessively increased.

The compensation image generator 130 generates a compensation image data signal DAT′ based on the data accumulation value for the pixel. The compensation image data signal DAT′ is the image data signal to compensate for the difference of the deterioration degree for the pixel. The compensation image generator 130 sets the data accumulation value of the maximum light emitting pixel, where the light is most largely emitted during the data accumulation period, as the maximum data accumulation value. The compensation image generator 130 generates the compensation image data signal DAT′ to offset the difference between the maximum data accumulation value and each of the remaining pixels' data accumulation value.

The compensation image generator 130 adds each weight value coefficient of each of the plurality of pixels to the data accumulation value for the pixel to obtain the maximum data accumulation value and each data accumulation value of the remaining pixels. The weight value coefficient is determined according to the accumulation value remaining after compensation by the compensation image data signal DAT′ of the difference between each data accumulation value of the remaining pixels and the maximum data accumulation value. If the remaining accumulation value is high, then the weight value coefficient is high. The weight value coefficient for each pixel may be stored to the memory 120.

When generating the second compensation image data signal to display the second compensation image after the first compensation image is displayed by the first compensation image data signal, the compensation image generator 130 adds the difference between the data accumulation value of the remaining pixels generated by the normal images, which are displayed between the first compensation image and the second compensation image, and the maximum data accumulation value to the accumulation value coefficient. That is, the compensation image generator 130 consecutively accumulates the difference between the data accumulation value of each pixel, which is generated whenever the normal image is displayed, and the maximum data accumulation value, and reflects it when generating the compensation image data signal.

Each deterioration degree of each of the plurality of pixels may correspond to the deterioration degree of the maximum light emitting pixel where the data accumulation value is set as the maximum data accumulation value according to the display of the compensation image. That is, the difference of the deterioration degree between the plurality of pixels may be offset, and thereby, the differences in luminance of the pixels may be compensated.

FIG. 4 is a view of a method of compensating a luminance difference between pixels caused by deterioration of one or more of the pixels according to an exemplary embodiment of the present invention.

Referring to FIGS. 3 and 4, the display device accumulates the input video signals R, G, and B for the pixel during a period in which a plurality of normal images are displayed, and stores the data accumulation value for the pixel, and displays the compensation image if the data accumulation value for the pixel reaches a value (e.g., a predetermined threshold value). A normal image refers to an image of one frame displayed according to the image data signal DAT generated according to the input video signals R, G, and B. The compensation image refers to an image of one frame displayed according to the compensation image data signal DAT′ generated to compensate for the difference of the deterioration degree for the pixel.

The signal controller 100 accumulates the input video signals R, G, and B for the pixel while displaying the normal image, and stores the data accumulation value for the pixel to the memory 120. If the data accumulation value for the pixel stored in the memory 120 is transmitted to the compensation image generator 130, the compensation image generator 130 generates the compensation image data signal DAT′ to offset the difference of the deterioration degree for the pixel based on the data accumulation value. The compensation image generator 130 displays the compensation image for a period (e.g., predetermined period) between the display of a plurality of normal images. That is, the compensation image generator 130 transmits the compensation image data signal DAT′ with a cycle (e.g., a predetermined cycle) to the data driver 300 to display the compensation image while, or amid, displaying a plurality of normal images. The compensation image may be displayed one time or more, and the compensation image may be displayed with an interval of a degree that may not be visually recognized by a viewer when the compensation image is displayed between the normal images.

For example, a first pixel emits light with the gray level 200 among 256 gray levels during ten frames before the display of the compensation image, such that the data accumulation value is 2000, and a second pixel emits light with the gray level 150, such that the data accumulation value is 1500. When the data accumulation value of the first pixel is set as the maximum data accumulation value, the difference between the maximum data accumulation value and the data accumulation value of the second pixel is 500. To offset the difference of the deterioration degree of the first pixel and the second pixel, the difference of 500 between the data accumulation value of the second pixel and the maximum data accumulation value is to be compensated.

For this, the first compensation image data signal is generated to decrease the difference between the data accumulation value of the second pixel and the maximum data accumulation value. The gray level to display the first compensation image generated by the first compensation image data signal is 256 gray level, such that the second pixel may be displayed with the gray level 255 when the first pixel of the maximum light emitting pixel is displayed with the grayscale 0 in the compensation image. The remaining accumulation value becomes 245 after the display of the first compensation image among the difference between the data accumulation value of the second pixel and the maximum data accumulation value, and the weight value coefficient of the second pixel becomes 245 as the remaining accumulation value.

When generating the second compensation image data signal to display the second compensation image after display of the first compensation image, for example, the difference between the accumulation value of the second pixel and the maximum data accumulation value may become 150 by the normal images displayed between the first compensation image and the second compensation image. At this time, the accumulation value difference to be compensated for the second pixel is 395, which is the weight value coefficient 245 of the second pixel added to the difference of 150 between the data accumulation value of the second pixel and the maximum data accumulation value. The second pixel may be displayed with the maximum gray level of 255 when generating the second compensation image data signal and the remaining accumulation value of 140 may be the weight value coefficient of the second pixel.

Through this method, the difference between the data accumulation value for each pixel and the maximum data accumulation value generated whenever the normal image is displayed may be consistently accumulated by using the weight value coefficient. By displaying the compensation image generated by the compensation image data signal reflecting the difference between the data accumulation value for each of the remaining pixels and the maximum data accumulation value, the difference of the deterioration degree for each of the pixels may be offset. Also, the deterioration degree of the plurality of pixels may correspond to the deterioration degree of the maximum light emitting pixel of which the largest amount of light is emitted during the data accumulation period.

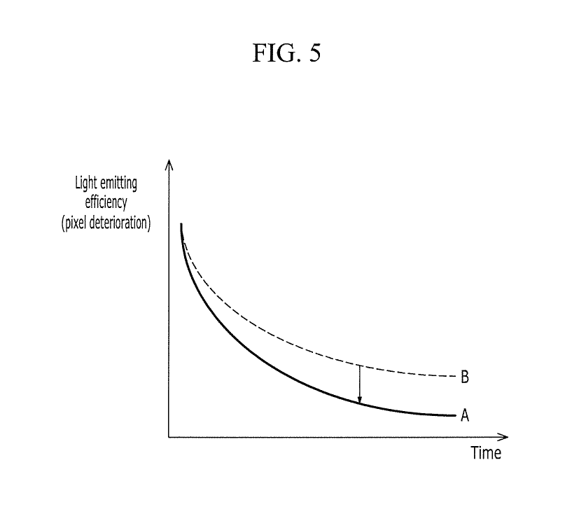

FIG. 5 is a graph of a deterioration curve of a pixel according to time.

Referring to FIG. 5, the graph shows that the luminous efficiency of a pixel is deteriorated according to time, that is, the deterioration of the pixel progresses.

“A” represents a deterioration curve of the first pixel (the maximum light emitting pixel) from which the light is most largely emitted. “B” represents a deterioration curve of the second pixel from which the light emitted is less than that of the first pixel. The luminous efficiency is decreased more in the first pixel than the second pixel. That is, the degree of deterioration due to time is greater in the first pixel than in the second pixel.

The deterioration curve of the second pixel may be adjusted to correspond to the deterioration curve of the first pixel by displaying the compensation image offsetting the difference between the data accumulation value of the first pixel and the data accumulation value of the second pixel. That is, the first pixel and the second pixel may be deteriorated by the same degree, and the luminance difference between the pixels according to the difference of the deterioration degree for the pixel is not generated.

All pixels are deteriorated by substantially the same degree such that the deterioration of the entire pixels may be uniformly compensated. Next, a method of uniformly compensating for the deterioration of all pixels will be described with reference to a luminance curve of the pixel.

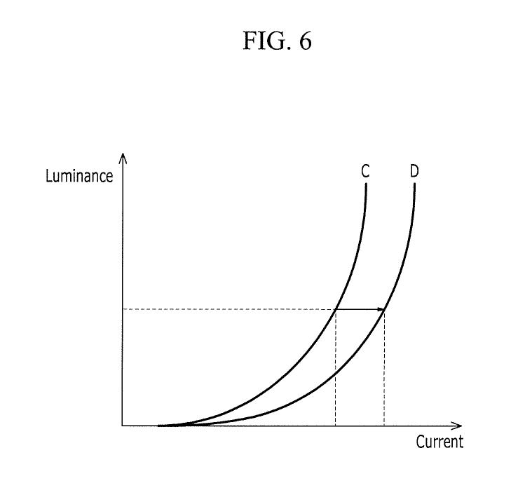

FIG. 6 is a graph of a luminance curve of a pixel with regard to current.

FIG. 6 represents a luminance curve of a pixel for a current flowing to an OLED, wherein “C” is a luminance curve of all pixels at a first time, and “D” is a luminance curve of all pixels at a second time. The second time is a time after the first time and after the deterioration of all pixels has progressed.

As the deterioration of all pixels progresses, to display the same luminance as that displayed before the deterioration, the current amount of the pixel current flowing to the OLED must increase. The compensation image generator 130 may apply a compensation value for increasing the pixel current according to the deterioration degree and the luminance of all pixels to the image data signal DAT. The deterioration degree of all pixels may be obtained from the deterioration curve “A” of the first pixel where the light is most largely emitted in FIG. 5. That is, the compensation image generator 130 increases the pixel current with reference to the deterioration degree of the first pixel where the light is most largely emitted to compensate for the deterioration degree of all pixels. The compensation value for increasing the pixel current according to the deterioration degree and the luminance of all pixels may be stored in a look-up table.

To compensate the deterioration of a plurality of pixels, a method of measuring each deterioration degree of each of the plurality of pixels and calculating a compensation image data signal for each pixel complicates the structure of the display device and increases the power consumption of the display device. Also, an additional time to measure each deterioration degree of a plurality of pixels and calculate a compensation image data signal is required, and an error according to a measuring error may be generated.

The method provided in embodiments of the present invention offsets the difference of the deterioration degree for the pixel through the constitution of storing the data accumulation values such that the luminance difference between the pixels according to the deterioration of the pixels may be easily compensated. Also, all pixels are deteriorated with the degree such that the deterioration of all pixels may be uniformly compensated, and a complicated calculation process of calculating the compensation image data signals reflecting each deterioration degree of a plurality of pixels is not necessary.

The drawings and the detailed description described above are examples of embodiments for the present invention and are provided to explain aspects of the present invention, and the scope of the present invention described in the claims is not limited thereto. Therefore, it will be appreciated by those skilled in the art that various modifications may be made and other equivalent embodiments are available. Accordingly, the actual scope of the present invention must be determined by the spirit of the appended claims, and equivalents thereof.

Description of Some of the Reference Characters

| | |
|---|---|
| 100: signal controller | 110: data accumulator |
| 120: memory | 130: compensation image generator |
| 200: scan driver | 300: data driver |
| 400: power supply unit | 500: display unit |

What is claimed is:

1. A display device comprising:
a display unit comprising a plurality of pixels; and
a signal controller for generating a compensation image data signal for offsetting a difference of a deterioration degree of a pixel from among the plurality of pixels, based on a data accumulation value of an input video signal of the pixel for displaying a normal image to the display unit,
wherein the signal controller is configured to generate the compensation image data signal for offsetting a difference between a maximum data accumulation value of a maximum light emitting pixel from among the plurality of pixels and each data accumulation value of remaining pixels from among the plurality of pixels.

2. The display device of claim 1, wherein the signal controller is configured to add a weight value coefficient of each of the plurality of pixels to the data accumulation value for a corresponding one of the plurality of pixels to obtain the maximum data accumulation value of the maximum light emitting pixel and each data accumulation value of the remaining pixels.

3. The display device of claim 2, wherein the weight value coefficient of each of the plurality of pixels corresponds to the data accumulation value remaining after compensation by the compensation image data signal for offsetting the difference between the maximum data accumulation value of the maximum light emitting pixel and the data accumulation value of each of the remaining pixels.

4. The display device of claim 1, wherein the signal controller is configured to generate the compensation image data signal for a compensation image to be displayed between a plurality of normal images in a cycle.

5. The display device of claim 1, wherein the signal controller is configured to generate an image data signal to display the normal image to increase respective pixel currents flowing to the plurality of pixels in reference to the deterioration degree of the maximum light emitting pixel.

6. A signal controller for a display device comprising:
a data accumulator for accumulating an input video signal corresponding to a pixel of a plurality of pixels to display a normal image;
a memory for storing a data accumulation value corresponding to the pixel, the data accumulation value being accumulated with the input video signal corresponding to the pixel; and
a compensation image generator for generating a compensation image data signal for offsetting a difference between a maximum data accumulation value of a maximum light emitting pixel from among the plurality of pixels and the data accumulation value of each of remaining pixels from among the plurality of pixels.

7. The signal controller of claim 6, wherein the compensation image generator is configured to add a weight value coefficient of each of the plurality of pixels to the data accumulation value for the pixel to obtain the maximum data accumulation value of the maximum light emitting pixel and each data accumulation value of the remaining pixels.

8. The signal controller of claim 7, wherein each weight value coefficient of the plurality of pixels is determined according to the data accumulation value remaining after compensation by the compensation image data signal for offsetting the difference between the maximum data accumulation value of the maximum light emitting pixel and each data accumulation value of the remaining pixels.

9. The signal controller of claim 6, wherein the memory is configured to store the data accumulation value for the pixel during a data accumulation period, to transmit the data accumulation value for the pixel to the compensation image generator, and to initialize the data accumulation value for the pixel.

10. The signal controller of claim 6, wherein the compensation image generator is configured to generate the compensation image data signal for a compensation image to be displayed between a plurality of normal images in a cycle.

11. The signal controller of claim 6, wherein the compensation image generator is configured to generate an image data signal to display the normal image to increase respective pixel currents flowing to the plurality of pixels in reference to a deterioration degree of the maximum light emitting pixel.

12. A method of driving a display device, comprising:
displaying a plurality of normal images generated by an image data signal and accumulating the image data signal for a pixel to store a data accumulation value for the pixel; and
displaying a compensation image generated by a compensation image data signal to offset a difference of a deterioration degree for the pixel,
wherein the compensation image data signal offsets differences between a maximum data accumulation value of a maximum light emitting pixel from among a plurality of pixels and data accumulation values of each of remaining pixels from among the plurality of pixels.

13. The method of claim 12, wherein the compensation image is displayed between the plurality of normal images in a cycle.

14. The method of claim 12, wherein a weight value coefficient of each of the plurality of pixels is added to the data accumulation value for the pixel to obtain the maximum data accumulation value and each data accumulation value of the remaining pixels.

15. The method of claim 14, wherein each weight value coefficient of the plurality of pixels is determined according to the data accumulation value remaining after compensation by the compensation image data signal for offsetting the differences between the maximum data accumulation value of the maximum light emitting pixel and each data accumulation value of the remaining pixels.

16. The method of claim 12, further comprising increasing respective pixel currents flowing to the plurality of pixels in reference to the deterioration degree of the maximum light emitting pixel to compensate deterioration of all of the pixels.
